(19) United States
(12) Patent Application Publication
(10) Pub. No.: US 2005/0242125 A1
(43) Pub. Date: Nov. 3, 2005

(54) Beverage bottle with spray device

(76) Inventor: Haruko Yamaguchi, Funabashi-shi (JP)

Correspondence Address: Haruko Yamaguchi;Room 104, 5-23-10 Yakuendai, Funabashi-shi, Chiba, 274-0077, JP

(21) Appl. No.: 11/097,797

(22) Filed: Apr. 4, 2005

(30) Foreign Application Priority Data
Apr. 16, 2004 (JP) JP2004-149770

(51) Int. Cl. G01F 11/06; G01F 11/30

(52) U.S. Cl. 222/321.7

(57) ABSTRACT

A beverage bottle with spray device including a bottle 9 and a spray device 10 which is attached on top of the bottle 9 and which includes a lower part of inner lid 2 of which a sealing film 1 is arranged on top, an upper part of inner lid 5 of which a spray 3 is arranged on top and a spray pipe 4 is stored inside, a joint 6 which connects the lower part of inner lid 2 and the upper part of inner lid 5, a lower part of outer lid 7 and an upper part of outer lid 8 which are arranged outside of the lower part of inner lid 2 and the upper part of inner lid 5.

### CROSS-REFERENCE TO RELATED APPLICATIONS

The present application claims the benefit of patent application number JP2004-149770, filed in Japan on Apr. 16, 2004, the subject matter of which is hereby incorporated herein by reference.

### FIELD OF THE INVENTION

Said present invention generally relates to a beverage bottle.

### BACKGROUND OF THE INVENTION

Conventional art of beverage bottle does not have a spray device. However, it is a disadvantage of known beverage bottle that can not heal hotness of body at the same time of quenching thirst.

### SUMMERY OF THE INVENTION

It is one object of said present invention to provide a beverage bottle which user can heal hotness of skin as well as quenching thirst at the same time.

It is another object of said invention to provide a beverage bottle which has a design suitable for long term storage.

With said above and other objects in view said invention provides a beverage bottle with spray device comprising a bottle 9 and a spray device 10 which is attached on top of said bottle 9 and which includes a lower part of inner lid 2 of which a sealing film 1 is arranged on top, an upper part of inner lid 5 of which a spray 3 is arranged on top and a spray pipe 4 is stored inside, a joint 6 which connects the lower part of inner lid 2 and the upper part of inner lid 5, a lower part of outer lid 7 and an upper part of outer lid 8 which are arranged outside of the lower part of inner lid 2 and the upper part of inner lid 5.

### BRIEF DESCRIPTION OF THE DRAWINGS

Said invention will now be described by way of example with reference to said accompanying drawings in which:

FIG. 1 shows a perspective view of a beverage bottle embodying said invention,

FIG. 2 shows a view of said invention partially cut away,

FIG. 3 shows a view of said invention when drinking,

FIG. 4 shows a view of said invention when spraying.

### DETAILED DESCRIPTION OF THE PREFERRED EMBODIMENT

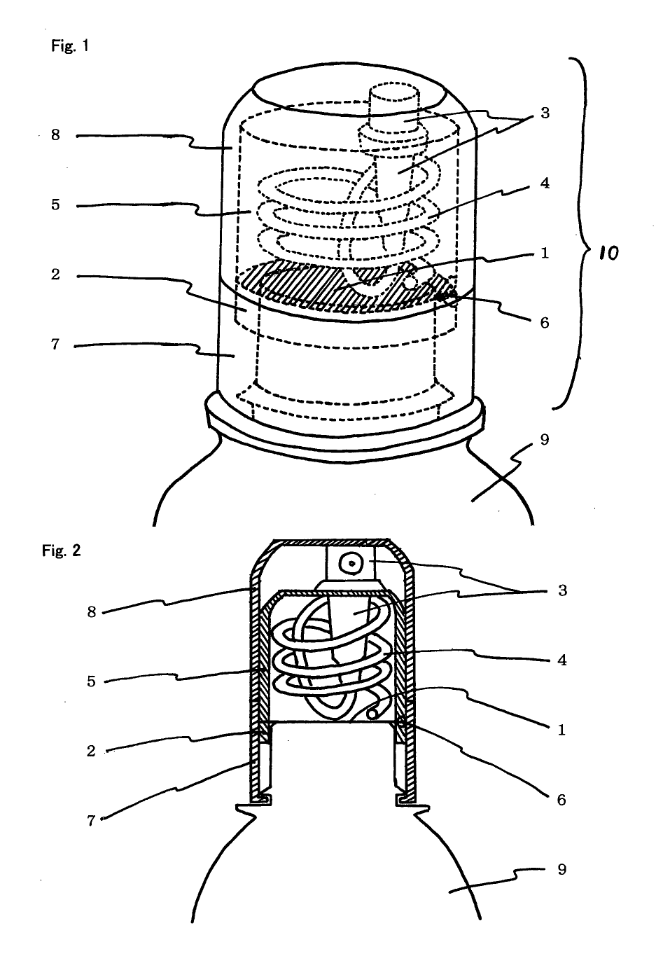

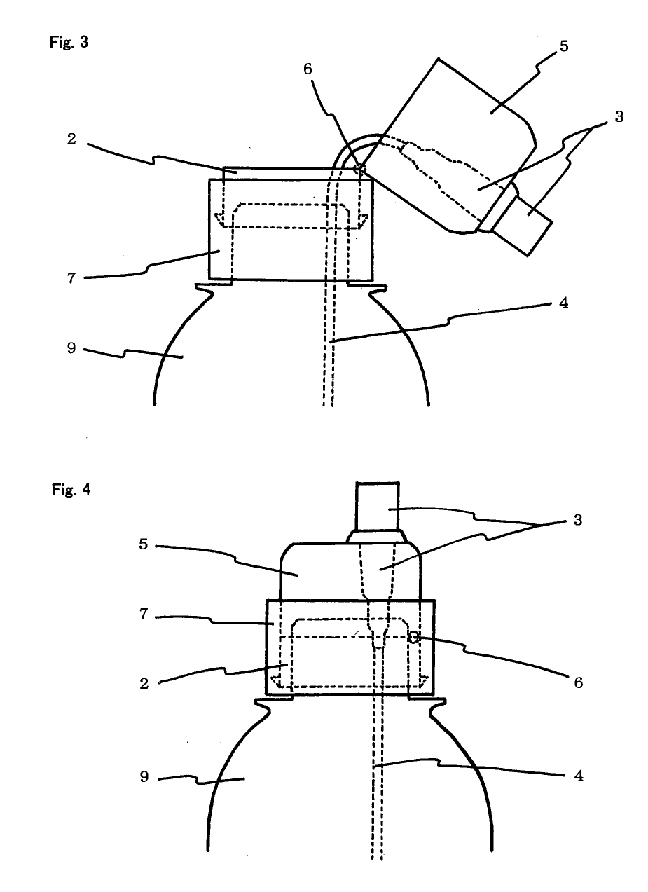

Referring to FIG. 1, a sealing film 1 is placed on top of a lower part of inner lid 2.

A spray 3 is arranged on an upper part of inner lid 5, and a spray pipe 4 is stored inside of the upper part of inner lid 5.

The lower part of inner lid 2 and the upper part of inner lid 5 are connected by a joint 6.

A lower part of outer lid 7 and an upper part of outer lid 8 is arranged outside of the lower part of inner lid 2 and the upper part of inner lid 5.

A spray device 10 comprising from the above structure is attached on a bottle 9, in which drinkable water is filled.

In order to use said present invention for drinking water, firstly take out the upper part of outer lid 8. Secondly pull up the upper part of inner lid 5 so that the joint 6 is coming higher than the lower part of outer lid 7, and then fall down the upper part of inner lid 5 and remove the sealing film 1 which is placed on top of the lower part of inner lid 2.

In order to use said present invention for spraying, take out one side of the spray pipe 4 from the upper part of inner lid 5 and put the spray pipe 4 into the bottle 9 deeply, and then pull back the upper part of inner lid 5 to the upright position and push down and fix the upper part of inner lid 5 to the lower part of outer lid 7.

While preferred embodiments have been shown and described, various modifications and substitutions may be made without departing from said spirit and scope of said invention.

Accordingly, it is to be understood that said present invention has been described by way of example, and not by limitation.

1. A beverage bottle with spray device comprising:
a bottle 9 to attach a spray device 10 thereon;
a spray device 10 which includes a lower part of inner lid 2 of which a sealing film 1 is arranged on top, an upper part of inner lid 5 of which a spray 3 is arranged on top and a spray pipe 4 is stored inside, a joint 6 which connects the lower part of inner lid 2 and the upper part of inner lid 5, a lower part of outer lid 7 and an upper part of outer lid 8 which are arranged outside of the lower part of inner lid 2 and the upper part of inner lid 5.

2. A beverage bottle with spray device as defined by claim 1, therein:
purified water including distilled water is filled in said bottle 9.

3. A beverage bottle with spray device as defined by claim 1, therein:
purified water including distilled water with scent is filled in said bottle 9.

4. A beverage bottle with spray device as defined by claim 1, therein:
mineral water is filled in said bottle 9.

5. A beverage bottle with spray device as defined by claim 1, therein:
mineral water with scent is filled in said bottle 9.

6. A beverage bottle with spray device as defined by claim 1, therein:
soft drink is filled in said bottle 9.

7. A beverage bottle with spray device as defined by claim 1, therein:
alcohol is filled in said bottle 9.

8. A beverage bottle with spray device as defined by claim 1, therewith:
said spray pipe 4 is preset into said bottle 9 without stored in said upper part of inner lid 5, without said sealing film 1 on said lower part of inner lid 2.

9. A beverage bottle with spray device as defined by claim 1, therewith:
said spray pipe 4 is preset into said bottle 9, in which purified water including distilled water is filled, without stored in said upper part of inner lid 5, without said sealing film 1 on said lower part of inner lid 2.

10. A beverage bottle with spray device as defined by claim 1, therewith:
said spray pipe 4 is preset into said bottle 9, in which purified water including distilled water with scent is filled, without stored in said upper part of inner lid 5, without said sealing film 1 on said lower part of inner lid 2.

11. A beverage bottle with spray device as defined by claim 1, therewith:
said spray pipe 4 is preset into said bottle 9, in which mineral water is filled, without stored in said upper part of inner lid 5, without said sealing film 1 on said lower part of inner lid 2.

12. A beverage bottle with spray device as defined by claim 1, therewith:
said spray pipe 4 is preset into said bottle 9, in which mineral water with scent is filled, without stored in said upper part of inner lid 5, without said sealing film 1 on said lower part of inner lid 2.

13. A beverage bottle with spray device as defined by claim 1, therewith:
said spray pipe 4 is preset into said bottle 9, in which soft drink is filled, without stored in said upper part of inner lid 5, without said sealing film 1 on said lower part of inner lid 2.

14. A beverage bottle with spray device as defined by claim 1, therewith:
said spray pipe 4 is preset into said bottle 9, in which alcohol is filled, without stored in said upper part of inner lid 5, without said sealing film 1 on said lower part of inner lid 2.

15. A spray device which includes said spray device 10 defined by claim 1 and which is designed to attach to the conventional beverage bottle.
